(19) United States
(12) Patent Application Publication
(10) Pub. No.: US 2010/0206023 A1
(43) Pub. Date: Aug. 19, 2010

(54) LOCKING DEVICE WITH A POWER SUPPLY UNIT

(75) Inventor: Reinhard Pöllabauer, Vienna (AT)

Correspondence Address: CHAPMAN AND CUTLER, 111 WEST MONROE STREET, CHICAGO, IL, 60603, US

(73) Assignee: EVVA Sicherheitstechnologie GmbH, Vienna (AT)

(21) Appl. No.: 12/733,494

(22) PCT Filed: Aug. 22, 2008
(86) PCT No.: PCT/AT2008/000298

§ 371 Date: Mar. 4, 2010

(30) Foreign Application Priority Data
Sep. 5, 2007 (AT) A 1383/2007

(51) Int. Cl. E05B 47/00; H01M 8/00

(52) U.S. Cl. 70/275; 429/400

(57) ABSTRACT

In a locking device with a power supply unit, the energy supply unit includes at least one chamber for a liquid or a gas as energy carrier or electrolyte former for a battery.

The invention relates to a locking device with a power supply unit.

Electric or electronic locks and, in particular, cylinder locks, in addition to mechanical locking means to be locked mechanically by conventional keys, as a rule, comprise at least one locking mechanism which is actuatable either electro-magnetically or by a motor and which will only be released after an identification check. The electronic circuit for the identification check usually cooperates with suitable identification media in a contactless manner or through contacts, whereby a check whether the respective identification medium is authorized to lock the lock is performed in the electronic evaluation circuit. After a successful verification of the identity the lock will be released.

In order to supply such electric or electronic locking means with energy, a permanent power supply of the lock and frequently also of the key is usually required, to which end it has to be ensured, in addition to the expenditure involved in such a permanent power supply, that an interruption-free power supply will be available to keep the lock functioning in any situation.

Electric or electronic locks can be supplied with energy in any manner whatsoever. In addition to providing a connection to the network or a supporting battery, proposals have also become known in which the lock or the key comprises a converter for converting mechanical energy into electric energy. Such converters are, for instance, designed as electric generators comprising a magnetic circuit and an induction coil crossed by the magnetic flux of the former, the magnetic circuit or the induction coil being designed as a movable component and the respectively other part as a fixed component. In those cases, the movement of the movably arranged component induces an induction voltage in the induction system. Such a configuration ensures the autarchic supply with energy, since the electric energy produced can be intermediately stored in an energy storage and made available, in case of need, to the electric circuit for the identification check and/or the electric actuation of the lock.

However, flywheel generators are, for instance, impractical for use in stationarily arranged locks inasmuch as the flywheel cannot be readily put in motion if external actuating means are to be renounced. Flywheel generators are at best suitable for integration in keys, since the flywheel will in that case be set in motion by being constantly taken along and hence subjected to mechanical vibrations similarly to a wristwatch. Another disadvantage of flywheel generators is the relatively inefficient mode of operation, since the mounting of the flywheel involves significant friction losses.

Also other components of locking devices such as, for instance, fittings, knobs, read and/or write devices for electronic keys and/or identification media or network components in a networked access control system would require constant power supply.

The present invention aims to improve the power supply of locking products and components, with said power supply having to be safeguarded independently of the power supply network and the drawbacks of hitherto known power supply facilities having to be avoided. The energy carrier, in particular, is to be readily renewed at any time, if required, without involving complex retrofitting work or the like. The renewal of the energy carrier is to be performed in a simple manner by anybody without technical knowledge. Furthermore, the invention aims to simplify the provision of electric power for closing components so as to enable the realization of additional functions without taking into account the energy consumption involved.

To solve this object, the present invention provides a locking device in which the energy supply unit comprises at least one chamber for a liquid or a gas as energy carrier or electrolyte former for a battery. By using a liquid or a gas as energy carrier or electrolyte former for a battery, the power supply unit can be recharged in a simple manner by refilling the respective liquid or gas. With the appropriate configuration of the power supply unit, a liquid or a gas which are generally commercially available can be used as energy carrier or as electrolyte former such that the procurement of the refill will be accordingly simplified.

In order to facilitate the refilling of medium, it is provided according to a preferred configuration that the chamber includes a closeable opening for refilling the liquid or gas, respectively. In those cases where a liquefied gas is used as energy carrier, refilling of the chamber might become difficult, and in this respect the configuration is further developed such that the chamber is replaceably mounted in the power supply unit. The chamber can thus be removed from the power supply unit when the energy carrier contained therein has been depleted, and replaced with a prepared, filled-up chamber. In the case of liquefied gases, the chamber will be designed as a high-pressure container such as, for instance, a high-pressure cartridge and can be safely arranged in the power supply unit by appropriate means.

According to a preferred further development, it is provided that the power supply unit comprises a fuel cell and the chamber is designed as a reservoir for an optionally liquefied anodic or cathodic gas. Such a fuel cell generally comprises a galvanic cell which converts into electric energy the chemical reaction energy of a continuously fed fuel (energy carrier) and an oxidant. A fuel cell, as a rule, is comprised of two electrodes which are separated from each other by a membrane or an electrolyte. The fuel (e.g. hydrogen, methane, methanol or glucose solutions) flows around the anode and is oxidized there. The oxidant (e.g., oxygen, hydrogen peroxide or potassium thiocyanate) flows around the cathode and is reduced there. The employed materials differ as a function of the type of fuel cell employed. The electrode plates/bipolar plates in most cases are made of metal or carbon nanotubes. For a better catalysis, they are coated with a catalyst, e.g. platinum or palladium. Dissolved lyes or acids, alkalicarbonate melts, ceramics or membranes may serve as electrolytes. The fuel is catalytically oxidized on the anode and converted into ions while releasing electrons. Through the ion exchange membrane, the latter pass into the chamber containing the oxidant. The electrons are withdrawn from the fuel cell, flowing to the cathode via an electric consumer. On the cathode, the oxidant is reduced to anions by taking up the electrons while simultaneously reacting to water with the protons that have migrated to the cathode through the electrolyte (with hydrogen as fuel and oxygen as oxidant).

In the context of the present invention, low-temperature fuel cells are particularly preferred in order to avoid the development of heat and damage to the components of the respective locking devices.

According to a preferred further development, it is provided according to the invention that the fuel cell is designed as a DMFC cell (direct methanol fuel cell). Such fuel cells are characterized by easy handling and the use of just methanol as a fuel.

Fuel cells are generally characterized by a high level of efficiency and can be declared particularly environmentally friendly. This enables locking devices to be equipped with power supply units without hesitation, the capacity of such a power supply being sufficient for an extremely long period of operation and its lifetime being extendible at any time by refilling the appropriate fuel.

The fuel cell itself, as a rule, ensures sufficient power supply. The operation of a fuel cell may, however, involve problems if the provided operating temperatures are fallen short of or exceeded. This may in fact cause temporary power supply failures. In order to bridge such power outages, it is provided according to a preferred configuration that the power supply unit, in addition to a fuel cell, comprises an accumulator fed by the fuel cell. By providing an accumulator fed by the fuel cell, the continuous supply of power will be reliably ensured.

In the context of the present invention, an alternative configuration in which the medium stored in the chamber serves as an electrolyte former may be provided instead of a fuel cell in which the liquid or gas stored in the chamber serves as a fuel. In this respect, the configuration is advantageously devised such that the power supply unit comprises a battery activated by a liquid, in particular water, and in which a liquid, in particular water, filled into the chamber forms the electrolyte for the battery along with other substances. Such a water-activated battery is, for instance, known from EP 0 692 834 B1. After filling the liquid, in particular water, into the chamber, which preferably separates the anode from the cathode, an electrolyte will form within the chamber, thus enabling the activation of an electrochemical process in the chamber and hence the supply of power. Such a configuration offers the advantage that power will not be supplied unless sufficient water and hence electrolyte is available in the battery. When the water contained in the chamber is exhausted, the flow of current will stop, wherein the capacity of the battery will not even be reduced at long periods of standstill or out-of-operation. It is only after the required amount of water has been refilled into the chamber of the battery, that the electrochemical process will start and power can again be supplied. Such a configuration has the advantage of power being merely generated with water filled in, wherein an extremely long lifetime of the battery is to be observed also in this case, since no capacity reduction is to be observed in the dried-out state of the battery.

Locking devices which, according to the invention, are provided with the power supply units of the above-described types encompass various components to the extent they require electric energy. In this respect, configurations are preferred, in which the locking device is designed as an electronic or non-electronic key, an identity means, a key tag, a motor-driven locking cylinder, a locking cylinder, a lock fitting, a lock actuating member such as, e.g., a knob, button, latchkey or the like, a read and/or write device for reading and/or writing and/or programming electronic keys and/or identity means, computer interface devices for connecting locking systems or parts thereof to computers or control units for locking systems.

In the following, the invention will be explained in more detail by way of exemplary embodiments.

In a first exemplary embodiment, an electronic key and, in particular, an identification card on which an electronic code or other identification data is stored is provided with a fuel cell for power supply. The electric energy may not only serve to maintain the basic functions of the identification card, but, for instance, also to signalize operating states or the like. This may, for instance, be effected via integrated LEDs or by the aid of an integrated display. Thus, it may, for instance, be possible to display the name or a photo of the individual to whom the identification card is issued. Furthermore, it is possible to display the authorizations assigned to the respective identification card. Another option consists in the incorporation of a lighting feature, which may, for instance, serve as a light source when operating a lock in the darkness. Novel, extremely thin types of fuel cells, for instance, enable their use in thin cards.

According to a further exemplary embodiment, a key tag is provided with a fuel cell. The power supply in this case is, above all, provided for lighting purposes and/or for the supply of the electronic data exchange with electric power. It is, however, also possible to attach a display device to a key tag, which will likewise have to be supplied with power. Thus, it is, for instance, possible to display the owner of a bunch of keys by a photo and his/her name.

According to a further exemplary embodiment, the power supply according to the invention may be provided on or in an electronic, mechatronic or mechanical key. Also in this case, the power supplied by the power supply unit can be fed to a display device to be used for the optical personalization of the key. Electronic keys which are designed as active transponders will, for instance, also require energy in order to transmit the identification code stored in the key to the authentication device of the lock.

According to a further exemplary embodiment, a wall reader may be equipped with a power supply unit according to the invention. Wall readers frequently serve to read out the identification code stored on an electronic key such as, for instance, a magnetic card or chip card and transmit the same to an authentication device in order to verify the access authorization as a function of the detected identification code and accordingly enable or block access. Additionally to such a reading function, initially mentioned devices may also have writing functions so as to enable data to be written on electronic keys or the like. The fuel cell in this case can power all electronic parts provided in the wall reader and/or the external parts connected with the wall reader or only parts of the electronics incorporated in the wall reader. It might, thus, also be possible to supply parts of the electronics in online wall readers by the bus system rather than by the fuel cell.

According to a further exemplary embodiment, a (motor-driven) locking cylinder may be provided with a power supply unit according to the invention. The power supplied by the power supply unit may serve to drive a display unit attached to the front face of the locking cylinder and displaying information for the user, operator of the system or a service engineer. Optionally, a lighting feature may also be incorporated to facilitate the insertion of a key into the locking cylinder core in the darkness. Furthermore, the power supplied by the power supply unit may serve to drive the motor of a motor-driven locking cylinder.

According to a further exemplary embodiment, a power supply unit according to the invention is provided in an actuating member for a lock, for instance a knob, or in a lock fitting. In this case, the power supplied by the power supply unit may serve to drive the electronics integrated in the fitting or in the knob, such as, for instance, the write/read electronics, decision-making electronics or enabling electronics.

In all of the above mentioned exemplary embodiments, the fuel cell may also be replaced with a water-activated battery.

1. A locking device comprising a power supply unit, wherein the power supply unit comprises a chamber replaceably mounted in the power supply unit for a liquid or a gas as an energy carrier for a battery, or for a liquid as an electrolyte former for a battery.

2. A locking device according to claim 1, wherein the chamber comprises a closeable opening for refilling the liquid or gas.

3. A locking device according to claim 1, wherein the power supply unit comprises a fuel cell, and the chamber is designed as a reservoir for an anodic or cathodic gas, or for a liquid power supplier.

4. A locking device according to claim 3, wherein the fuel cell is designed as a direct methanol fuel cell.

5. A locking device according to claim 3, wherein the power supply unit further comprises an accumulator fed by the fuel cell.

6. A locking device according to claim 1, wherein the chamber is for the liquid as an electrolyte former for the battery, said liquid is water, and said water filled into the chamber forms the electrolyte for the battery along with other substances.

7. A locking device according to claim 1, wherein the locking device is designed as an electronic key, a non-electronic key, a mechatronic key, an identity means, a key tag, a motor-driven locking cylinder, a locking cylinder, a lock fitting, a lock actuating member, a knob, a button, a latchkey, a read and/or write device for reading and/or writing and/or programming electronic keys and/or mechatronic keys and/or identity means, or a computer interface device for connecting locking systems or parts thereof to computers or to control units for locking systems.

8. A locking device according to claim 2, wherein the power supply unit comprises a fuel cell, and the chamber is designed as a reservoir for an anodic or cathodic gas, or for a liquid power supplier.

9. A locking device according to claim 3, wherein the anodic or cathodic gas is liquefied anodic or cathodic gas.

10. A locking device according to claim 8, wherein the anodic or cathodic gas is liquefied anodic or cathodic gas.

11. A locking device according to claim 4, wherein the power supply unit further comprises an accumulator fed by the fuel cell.

12. A locking device according to claim 2, wherein the locking device is designed as an electronic key, a non-electronic key, a mechatronic key, an identity means, a key tag, a motor-driven locking cylinder, a locking cylinder, a lock fitting, a lock actuating member, a knob, a button, a latchkey, a read and/or write device for reading and/or writing and/or programming electronic keys and/or mechatronic keys and/or identity means, or a computer interface device for connecting locking systems or parts thereof to computers or to control units for locking systems.

13. A locking device according to claim 3, wherein the locking device is designed as an electronic key, a non-electronic key, a mechatronic key, an identity means, a key tag, a motor-driven locking cylinder, a locking cylinder, a lock fitting, a lock actuating member, a knob, a button, a latchkey, a read and/or write device for reading and/or writing and/or programming electronic keys and/or mechatronic keys and/or identity means, or a computer interface device for connecting locking systems or parts thereof to computers or to control units for locking systems.

14. A locking device according to claim 4, wherein the locking device is designed as an electronic key, a non-electronic key, a mechatronic key, an identity means, a key tag, a motor-driven locking cylinder, a locking cylinder, a lock fitting, a lock actuating member, a knob, a button, a latchkey, a read and/or write device for reading and/or writing and/or programming electronic keys and/or mechatronic keys and/or identity means, or a computer interface device for connecting locking systems or parts thereof to computers or to control units for locking systems.

15. A locking device according to claim 5, wherein the locking device is designed as an electronic key, a non-electronic key, a mechatronic key, an identity means, a key tag, a motor-driven locking cylinder, a locking cylinder, a lock fitting, a lock actuating member, a knob, a button, a latchkey, a read and/or write device for reading and/or writing and/or programming electronic keys and/or mechatronic keys and/or identity means, or a computer interface device for connecting locking systems or parts thereof to computers or to control units for locking systems.

16. A locking device according to claim 6, wherein the locking device is designed as an electronic key, a non-electronic key, a mechatronic key, an identity means, a key tag, a motor-driven locking cylinder, a locking cylinder, a lock fitting, a lock actuating member, a knob, a button, a latchkey, a read and/or write device for reading and/or writing and/or programming electronic keys and/or mechatronic keys and/or identity means, or a computer interface device for connecting locking systems or parts thereof to computers or to control units for locking systems.
